(19) United States
(12) Patent Application Publication
(10) Pub. No.: US 2022/0132482 A1
(43) Pub. Date: Apr. 28, 2022

(54) Tone Reservation for Reducing Peak-to-Average Power Ratio

(71) Applicant: Nokia Technologies Oy, Espoo (FI)

(72) Inventors: Selahattin GOKCELI, Tempere (FI); Ismael Peruga Nasarre, Tampere (FI); Mikko Valkama, Nokia (FI); Kari Pajukoski, Oulu (FI); Esa Tiirola, Oulu (FI)

(73) Assignee: Nokia Technologies Oy

(21) Appl. No.: 17/506,865

(22) Filed: Oct. 21, 2021

(30) Foreign Application Priority Data
Oct. 23, 2020 (FI) 20206051

(51) Int. Cl. H04W 72/04

(52) U.S. Cl. CPC H04W 72/044

(57) ABSTRACT

This document discloses a solution for reducing peak-to-average power ratio in a radio device. According to an aspect, an apparatus includes circuitry configured for performing: acquiring a block of modulated symbols to be transmitted over a radio interface; transforming the block of modulated symbols from a time domain into a frequency domain for sub-carrier mapping; performing a time-domain peak detection procedure on the block of modulated symbols before said transforming; upon detecting at least one peak in the block of modulated symbols during the time-domain peak detection procedure, computing a peak correction signal for the block of modulated symbols and allocating the peak correction signal to one or more sub-carriers dedicated to the peak correction signal in the sub-carrier mapping; and upon detecting no peak in the block of modulated symbols during the time-domain peak detection procedure, omitting said computing and said allocating.

### FIELD

Various embodiments described herein relate to the field of wireless communications and, particularly, to using a tone reservation mechanism to reduce peak-to-average power ratio of a radio signal being transmitted.

### BACKGROUND

Methods for reducing a peak-to-average power ratio (PAPR) has been investigated, and it is an important topic in terms of power-efficiency of a transmitter having limited power resources. A terminal device of a cellular communication system is an example of such a transmitter. Modern communications employ various transmission schemes based on multi-carrier transmission, e.g. orthogonal frequency-division multiplexing (OFDM) and discrete Fourier Transform Spread OFDM (DFT-S-OFDM). DFT-S-OFDM is in some literature called a single-carrier OFDM or single-carrier frequency division multiple access (SC-FDMA). DFT-S-OFDM can be seen as a frequency domain generation of an SC-FDMA signal. In such systems, a tone reservation mechanism may be employed where some of sub-carriers of a multi-carrier signal are dedicated for correction symbols that modify the multi-carrier signal in such manner that the PAPR becomes reduced.

### BRIEF DESCRIPTION

Some aspects of the invention are defined by the independent claims.

Some embodiments of the invention are defined in the dependent claims.

The embodiments and features, if any, described in this specification that do not fall under the scope of the independent claims are to be interpreted as examples useful for understanding various embodiments of the invention. Some aspects of the disclosure are defined by the independent claims.

According to an aspect, there is provided an apparatus comprising means for performing: acquiring a block of modulated symbols to be transmitted over a radio interface; transforming the block of modulated symbols from a time domain into a frequency domain for sub-carrier mapping; performing a time-domain peak detection procedure on the block of modulated symbols before said transforming; upon detecting at least one peak in the block of modulated symbols during the time-domain peak detection procedure, computing a peak correction signal for the block of modulated symbols and allocating the peak correction signal to one or more sub-carriers dedicated to the peak correction signal in the sub-carrier mapping; and upon detecting no peak in the block of modulated symbols during the time-domain peak detection procedure, omitting said computing and said allocating.

In an embodiment, the means are configured, upon detecting no peak in the block of modulated symbols, to leave the sub-carriers dedicated to the peak correction signal empty.

In an embodiment, the means are configured to disable the peak detection procedure when there are available no sub-carriers dedicated to the peak correction signal.

In an embodiment, the means are configured to disable the peak detection procedure in response to detecting no sub-carriers dedicated to the peak correction signal in a scheduling grant message received from a serving access node.

In an embodiment, the means are configured to indicate, to the serving access node, capability for using sub-carriers reserved for peak correction when transmitting an uplink signal.

In an embodiment, the means are configured to receive, in response to indicating the capability to the serving access node, a configuration of sub-carriers reserved for the peak correction, wherein the configuration indicates a position of the sub-carriers reserved for the peak correction and at least condition when the sub-carriers reserved for the peak correction are available to the apparatus.

In an embodiment, means are configured to perform the time-domain peak detection procedure by filtering the block of modulated symbols with a filter having a response approximating a combined response of at least said transforming via a discrete Fourier transform and subsequent inverse discrete Fourier transform operations and by performing peak detection on the filtered block of modulated symbols.

In an embodiment, a time-domain amplitude response of said response has a form where a higher weight is assigned to filter coefficients at a center of the filter than to filter coefficients at an edge of the filter.

In an embodiment, the amplitude response is asymmetric with respect to a central coefficient of the filter such that the amplitude response is offset from the central coefficient towards coefficients at an end of the filter.

In an embodiment, a time-domain phase response of said response has a form where at least some of adjacent coefficients of the filter have an opposite phase value and at least some of the adjacent coefficients of the filter have an equal phase value.

In an embodiment, the means are configured to perform the time-domain peak detection procedure by using a threshold comparison with a threshold and, if the threshold is exceeded in the comparison, detect a peak caused by the modulated symbols, wherein the threshold is fixed per modulation scheme.

In an embodiment, the means comprise at least one processor and at least one memory including computer program code, the at least one memory and computer program code configured to, with the at least one processor, cause the performance of the apparatus.

According to an aspect, there is provided a method comprising: acquiring, by an apparatus, a block of modulated symbols to be transmitted over a radio interface; transforming, by the apparatus, the block of modulated symbols from a time domain into a frequency domain for sub-carrier mapping; performing, by the apparatus, a time-domain peak detection procedure on the block of modulated symbols before said transforming; upon detecting at least one peak in the block of modulated symbols during the time-domain peak detection procedure, computing by the apparatus a peak correction signal for the block of modulated symbols and allocating the peak correction signal to one or more sub-carriers dedicated to the peak correction signal in the sub-carrier mapping; and upon detecting no peak in the block of modulated symbols during the time-domain peak detection procedure, omitting by the apparatus said computing and said allocating.

In an embodiment, the apparatus is a terminal device of a cellular communication system.

In an embodiment, the apparatus leaves, upon detecting no peak in the block of modulated symbols, the sub-carriers dedicated to the peak correction signal empty.

In an embodiment, the apparatus disables the peak detection procedure when there are available no sub-carriers dedicated to the peak correction signal.

In an embodiment, the apparatus disables the peak detection procedure in response to detecting no sub-carriers dedicated to the peak correction signal in a scheduling grant message received from a serving access node.

In an embodiment, the apparatus indicates, to the serving access node, capability for using sub-carriers reserved for peak correction when transmitting an uplink signal.

In an embodiment, the apparatus receives, in response to indicating the capability to the serving access node, a configuration of sub-carriers reserved for the peak correction, wherein the configuration indicates a position of the sub-carriers reserved for the peak correction and at least condition when the sub-carriers reserved for the peak correction are available to the apparatus.

In an embodiment, the apparatus performs the time-domain peak detection procedure by filtering the block of modulated symbols with a filter having a response approximating a combined response of at least said transforming via a discrete Fourier transform and subsequent inverse discrete Fourier transform operations and by performing peak detection on the filtered block of modulated symbols.

In an embodiment, a time-domain amplitude response of said response has a form where a higher weight is assigned to filter coefficients at a center of the filter than to filter coefficients at an edge of the filter.

In an embodiment, the amplitude response is asymmetric with respect to a central coefficient of the filter such that the amplitude response is offset from the central coefficient towards coefficients at an end of the filter.

In an embodiment, a time-domain phase response of said response has a form where at least some of adjacent coefficients of the filter have an opposite phase value and at least some of the adjacent coefficients of the filter have an equal phase value.

In an embodiment, the apparatus performs the time-domain peak detection procedure by using a threshold comparison with a threshold and, if the threshold is exceeded in the comparison, detect a peak caused by the modulated symbols, wherein the threshold is fixed per modulation scheme.

According to an aspect, there is provided a computer program product embodied on a computer-readable medium and comprising a computer program code readable by a computer, wherein the computer program code configures the computer to carry out a computer process comprising: acquiring a block of modulated symbols to be transmitted over a radio interface; transforming the block of modulated symbols from a time domain into a frequency domain for sub-carrier mapping; performing a time-domain peak detection procedure on the block of modulated symbols before said transforming; upon detecting at least one peak in the block of modulated symbols during the time-domain peak detection procedure, computing a peak correction signal for the block of modulated symbols and allocating the peak correction signal to one or more sub-carriers dedicated to the peak correction signal in the sub-carrier mapping; and upon detecting no peak in the block of modulated symbols during the time-domain peak detection procedure, omitting said computing and said allocating.

In an embodiment, the computer program product further comprises program instructions configuring the computer to carry out the method according to any one of the above-described embodiments.

### LIST OF DRAWINGS

Embodiments are described below, by way of example only, with reference to the accompanying drawings, in which

FIG. 1 illustrates a wireless communication scenario to which some embodiments of the invention may be applied;

FIG. 2 illustrates a process for reducing peak(s) in a transmission signal according to an embodiment;

FIG. 3 illustrates a procedure for enabling/disabling the peak reduction according to an embodiment;

FIG. 4 illustrates a signalling diagram of a procedure for negotiating the peak reduction between a terminal device and an access node according to an embodiment;

FIG. 5 illustrates a response of a filter used in the peak reduction according to an embodiment;

FIG. 6 illustrates pre-filtering and associated peak detection according to an embodiment;

FIG. 7 illustrates a transmitter structure comprising some transmission functions related to peak reduction according to an embodiment; and

FIGS. 8 and 9 illustrate block diagrams of structures of apparatuses according to some embodiments of the invention.

### DESCRIPTION OF EMBODIMENTS

The following embodiments are examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

In the following, different exemplifying embodiments will be described using, as an example of an access architecture to which the embodiments may be applied, a radio access architecture based on long term evolution advanced (LTE Advanced, LTE-A) or new radio (NR, 5G), without restricting the embodiments to such an architecture, however. A person skilled in the art will realize that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network.

FIG. 1 shows terminal devices or user devices 100 and 102 configured to be in a wireless connection on one or more communication channels in a cell with an access node (such as (e/g)NodeB) 104 providing the cell. (e/g)NodeB refers to an eNodeB or a gNodeB, as defined in 3GPP specifications. The physical link from a user device to a (e/g)NodeB is called uplink or reverse link and the physical link from the (e/g)NodeB to the user device is called downlink or forward link. It should be appreciated that (e/g)NodeBs or their functionalities may be implemented by using any node, host, server or access point etc. entity suitable for such a usage.

A communications system typically comprises more than one (e/g)NodeB in which case the (e/g)NodeBs may also be configured to communicate with one another over links, wired or wireless, designed for the purpose. These links may be used not only for signalling purposes but also for routing data from one (e/g)NodeB to another. The (e/g)NodeB is a computing device configured to control the radio resources of communication system it is coupled to. The NodeB may also be referred to as a base station, an access point, an access node, or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 110 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station. 5G specifications support at least the following relay operation modes: out-of-band relay where different carriers and/or RATs (Radio access technologies) may be defined for an access link and a backhaul link; and in-band-relay where the same carrier frequency or radio resources are used for both access and backhaul links. In-band relay may be seen as a baseline relay scenario.

A relay node is called an integrated access and backhaul (IAB) node. It has also inbuilt support for multiple relay hops. IAB operation assumes a so-called split architecture having CU and a number of DUs. An IAB node contains two separate functionalities: DU (Distributed Unit) part of the IAB node facilitates the gNB (access node) functionalities in a relay cell, i.e. it serves as the access link; and a mobile termination (MT) part of the IAB node that facilitates the backhaul connection, A Donor node (DU part) communicates with the MT part of the IAB node, and it has a wired connection to the CU which again has a connection to the core network. In the multihop scenario, MT part (a child IAB node) communicates with a DU part of the parent IAB node.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. The user device may also utilize cloud. In some applications, a user device may comprise a small portable device with radio parts (such as a watch, earphones or eyeglasses) and the computation is carried out in the cloud. The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6GHz, cmWave and mmWave, and also being capable of being integrated with existing legacy radio access technologies, such as the LTE. Integration with the LTE may be implemented, at least in the early phase, as a system, where macro coverage is provided by the LTE and SG radio interface access comes from small cells by aggregation to the LTE. In other words, 5G is planned to support both inter-RAT operability (such as LTE-5G) and inter-RI operability (inter-radio interface operability, such as below 6GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and typically fully centralized in the core network. The low-latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks 112, such as a public switched telephone network or the Internet, or utilize services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 105) and non-real time functions being carried out in a centralized manner (in a centralized unit, CU 108).

It should also be understood that the distribution of functions between core network operations and base station operations may differ from that of the LTE or even be non-existent. Some other technology advancements probably to be used are Big Data and all-IP, which may change the way networks are being constructed and managed. SG (or new radio, NR) networks are being designed to support multiple hierarchies, where MEC servers can be placed between the core and the base station or node B (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway, maritime, and/or aeronautical communications. Satellite communication may utilize geostationary earth orbit (GEO) satellite systems, but also low earth orbit (LEO) satellite systems, in particular mega-constellations (systems in which hundreds of (nano)satellites are deployed). Each satellite 110 in the mega-constellation may cover several satellite-enabled network entities that create on-ground cells. The on-ground cells may be created through an on-ground relay node or by a gNB located on-ground or in a satellite.

It is obvious for a person skilled in the art that the depicted system is only an example of a part of a radio access system and in practice, the system may comprise a plurality of (e/g)NodeBs, the user device may have an access to a plurality of radio cells and the system may comprise also other apparatuses, such as physical layer relay nodes or other network elements, etc. At least one of the (e/g)NodeBs or may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)nodeBs), a home node B gateway, or HNB-GW (not shown in FIG. 1). A HNB Gateway (HNB-GW), which is typically installed within an operator's network may aggregate traffic from a large number of HNBs back to a core network.

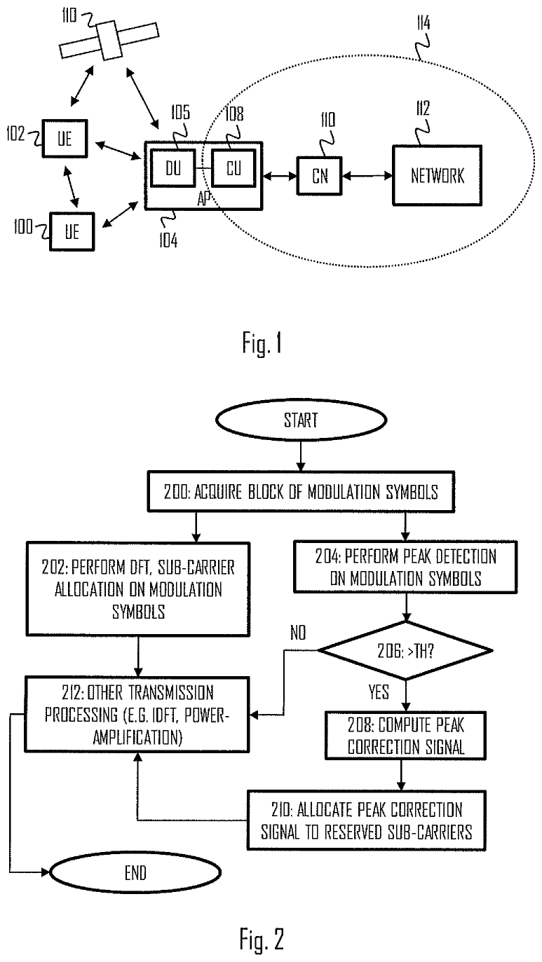

FIG. 2 illustrates a procedure for reducing peak-to-average power ratio (PAPR) in an apparatus, e.g. in a transmitter of a radio signal. The apparatus may be for the terminal device 100, 102, or it may be for the access node 104. Referring to FIG. 2, the procedure comprises: acquiring (block 200) a block of modulated symbols to be transmitted over a radio interface; transforming (block 202) the block of modulated symbols from a time domain into a frequency domain for sub-carrier mapping; performing (block 204) a time-domain peak detection procedure on the block of modulated symbols before said transforming; upon detecting (‘yes’ in block 206) at least one peak in the block of modulated symbols during the time-domain peak detection procedure, computing (block 208) a peak correction signal for the block of modulated symbols and allocating (block 210) the peak correction signal to one or more sub-carriers dedicated to the peak correction signal in the sub-carrier mapping; and upon detecting no peak in the block of modulated symbols during the time-domain peak detection procedure (‘no’ in block 206), omitting said computing and said allocating.

After the modulation symbols and the peak correction signal are allocated to the respective sub-carriers in blocks 202 and 210, other transmission signal processing functions may be performed on the resulting multi-carrier signal in block 212. The other functions may include performing inverse-transformation of the signal back to a time domain, conversion of the resulting signal to a radio frequency, and radio frequency transmission operations including power-amplification and transmission of the signal from an antenna.

The embodiment of FIG. 2 provides several advantages. First of all, peak detection subsequent computation of the peak correction signal enables reduction of the peak-to-average power ratio of the transmitted signal. This improves the efficiency of a power amplifier in the transmitter and reduces power consumption. Detection of the peaks before the Fourier transformation (into the frequency domain) also enables early and efficient peak detection and subsequent peak correction. Some embodiments described below also enable low-complexity peak detection.

As described in connection with FIG. 2, the peak detection may be performed on the modulation symbols before the Fourier transform. The peak detection may be performed before the Fourier transform or, as described in FIG. 2, the peak detection and the Fourier transform may be carried out in parallel processes. All the steps of FIG. 2 may, however, be made before inverse Fourier transform of a signal comprising the modulation symbols and the peak correction signal mapped to respective sub-carriers.

As known in the art, the sub-carriers of an SC-FDMA or a DFT-S-OFDM signal cannot necessarily be distinguished from the final signal that is transmitted from an antenna in a similar manner than from an OFDM signal, for example. This is because of the Fourier transform spreads the signals on the sub-carriers over the whole frequency domain. However, in some stage(s) of the transmission signal processing, the sub-carriers are distinguishable and, therefore, the SC-FDMA and DFT-S-OFDM transmission schemes are in some literature called virtual sub-carrier schemes.

In an embodiment of the process of FIG. 2, upon detecting no peak in the block of modulated symbols, the sub-carriers dedicated to the peak correction signal are left empty. In other embodiments, the sub-carriers dedicated to the peak correction signal are always utilized and occupied by the peak correction signal.

In an embodiment, the number of modulation symbols in the block equals to the size of the Fourier transform. The modulation symbols may have been modulated by using any modulation scheme supported by the system, e.g. phase-shift keying or quadrature amplitude modulation of any order.

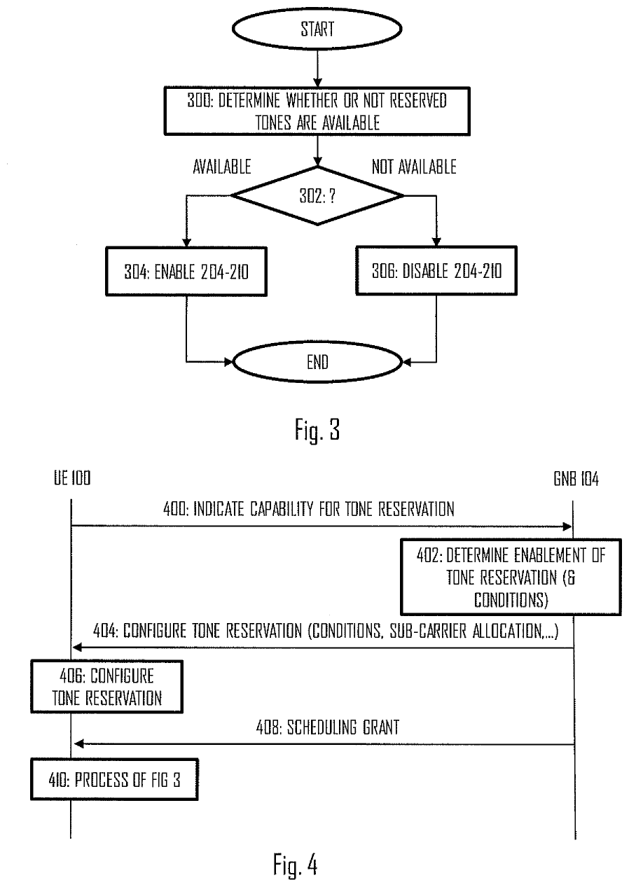

In an embodiment, the peak detection and correction is subject to the availability of the sub-carriers dedicated to the peak correction signal. FIG. 3 illustrates such an embodiment where the peak detection procedure is disabled when there are available no sub-carriers dedicated to the peak correction signal. The presence or the absence of such dedicated sub-carriers may correspond to whether or not tone reservation has been enabled for the apparatus executing the process of FIG. 2. Referring to FIG. 3, in block 300 it may be determined whether or not the tone reservation has been enabled, i.e. whether or not the sub-carriers dedicated to the peak correction signal are available. If it is determined in block 302 that such sub-carriers are not available, the peak detection and correction in blocks 204 to 210 may be disabled (block 306). On the other hand, if it is determined in block 302 that the sub-carriers are available, the blocks 204 to 210 may be enabled (block 304). The availability of the sub-carriers for the peak correction may be determined, for example, from a current RRC configuration, from received downlink control information received in a message from a serving access node (such as in an uplink scheduling grant), or a combination these.

In an embodiment where the process of FIG. 2 is implemented in a terminal device 100, 102, the terminal device indicates, to the serving access node 104, capability for using dedicated sub-carriers for peak correction when transmitting an uplink signal. The terminal device may indicate, for example, capability of using the peak correction for reducing the PAPR, maximum power emission, and/or a cubic metric of the transmitted signal. The cubic matric is a metric of actual reduction in power capability of the power amplifier. FIG. 4 illustrates a procedure for such an embodiment. Referring to FIG. 4, the terminal device 100 may indicate the capability for using the dedicated sub-carriers for peak correction when transmitting an uplink signal in step 400. In other words, the terminal device may in step 400 indicate the capability for exploiting tone reservation, provided that the access node 104 enables the tone reservation. The capability may be indicated in a radio resource control (RRC) layer message, for example, e.g. in a RRC connection setup request or a RRC reconfiguration message or a RRC signaling message defined for capability indication.

In block 402, the access node may determine whether or not to enable the tone reservation for the terminal device 100. The access node may specify a specific operational mode where the tone reservation is enabled. Accordingly, the tone reservation may be a semi-static feature that is reconfigured via higher layer signaling, e.g. on the RRC layer. The decision on whether or not to enable the tone reservation may depend on various factors, e.g. traffic load at the access node 104. Upon determining to configure the tone reservation, the access node may determine parameters of the tone reservation. The parameters may include allocation of the tones reserved for the peak correction to sub-carriers, conditions for enabling the reserved tone allocation, channels using the tone reservation, etc. The location of the reserved tones may be substantially static, e.g. at an either edge or both edges of the sub-carriers carrying information symbols or as interleaved with the sub-carriers carrying the information symbols. The condition may be specified such that the tone reservation is enabled for certain transmission formats specified in downlink control information (DCI). For example, the tone reservation may be enabled for one DCI format (e.g. 0_1, which is a dedicated/configurable format used e.g. for triggering uplink transmissions on a physical uplink shared channel, PUSCH) and disabled for another DCI format (e.g. 0_0 which is a fallback format in the specifications for 5G). The tone reservation may be enabled for certain uplink channels (e.g. the PUSCH, physical uplink control channel, PUCCH, or some formats of the PUCCH) and disabled for other uplink channels (e.g. the PUCCH or some formats of the PUCCH, or random access channel, RACH, or a random access message 3 transmitted on the PUSCH).

Upon determining the parameters, the access node may transmit a downlink message to the terminal device in step 404, indicating that the tone reservation has been enabled and, further, the above-described parameter(s) of the tone reservation. Upon receiving the message in step 404, the terminal device may configure the tone reservation feature in block 406. Then, upon receiving an uplink scheduling grant in step 408 from the access node, the terminal device may determine whether or not the conditions for enabling the peak correction have been met, e.g. whether or not there are currently allocated tones (sub-carriers) for the peak correction signal. The scheduling grant may indicate the DCI format and, accordingly, explicitly indicate whether or not the tone reservation is enabled. The terminal device may then use the process of FIG. 3 to evaluate whether or not to enable the peak detection and correction. If there are dedicated sub-carriers available for the peak correction signal, the terminal device may enable the peak detection and correction in the process of FIG. 3 (block 304) and use the peak correction in uplink transmission. If the tone reservation is not enabled by the scheduling grant, the terminal device may disable the peak detection procedure in the process of FIG. 3 (block 306).

In an embodiment, the enablement of the tone reservation is indicated by a predefined bit or a signaling state in the scheduling grant, e.g. the certain DCI format).

In an embodiment, the enablement of the tone reservation is determined on the basis of the selected modulation and coding scheme. For example, the access node may enable the tone reservation for one set of modulation and coding schemes and disable the tone reservation for another set of modulation and coding schemes. In another embodiment, the enablement of the tone reservation is determined on the basis of the selected modulation scheme. For example, the access node may enable the tone reservation for one set of modulation schemes and disable the tone reservation for another set of modulation schemes. In another embodiment, the enablement of the tone reservation is determined on the basis of the selected channel coding scheme. For example, the access node may enable the tone reservation for one set of channel coding schemes and disable the tone reservation for another set of channel coding schemes. In another embodiment, the enablement of the tone reservation is determined on the basis of a transmitted signal waveform. For example, the access node may enable the tone reservation for DFT-S-OFDM or SC-FDMA transmission waveforms and disable the tone reservation for other waveforms, e.g. OFDM. In another embodiment, the enablement of the tone reservation is determined on the basis of the selected transmission rank, e.g. a number of spatially multiplexed transmission channels between the terminal device and the serving access node. For example, the access node may enable the tone reservation for one set of ranks and disable the tone reservation for another set of ranks. In general, the enablement of the tone reservation may be determined on the basis of the transmission scheme. For example, the access node may enable the tone reservation for one set of (one or more) transmission schemes and disable the tone reservation for another set of (one or more) transmission schemes.

As described above, the enablement and configuration of the tone reservation may be signaled explicitly to the terminal device. In other embodiments, the enablement is implicit and dependent on certain conditions specified in the uplink scheduling grant, e.g. the size of the uplink resource allocation.

In an embodiment, the number of sub-carries dedicated to the peak correction signal is an integer number of physical resource blocks (PRB) allocated to the terminal device in the scheduling grant for uplink transmission.

In an embodiment, the time-domain peak detection procedure is performed by filtering the block of modulated symbols with a filter having a response approximating a combined response of at least a discrete Fourier transform (DFT) and subsequent inverse DFT operations and by performing peak detection on the filtered block of modulated symbols. It has been discovered that certain combinations of the modulation symbols result in one or more peaks in a signal at the output of the inverse DFT, and the peak(s) increase(s) the PAPR of the signal at the power amplified, thus degrading the efficiency of the power amplifier and/or other radio frequency components. Reduction of the PAPR by compensating for such peak(s) would be advantageous, particularly if the detection of such peaks can be performed with low complexity. Let us first define a signal model for the peak detection.

As the first step of the DFT-s-OFDM waveform processing, the modulation data symbols are created from bits by using a modulation scheme such as quadrature amplitude modulation (QAM) or phase shift keying (PSK) such as binary or quadrature PSK. The generated data symbol at index l∈{0,1, . . . , N_{DFT}−1} is represented by d[l]. Then, with DFT precoding, frequency-domain samples can be obtained as

$$X [ k ] = \frac{1}{\sqrt{{N}_{DFT}}} {\sum }_{l = 0}^{{N}_{DFT} - 1} d [ l ] {e}^{\frac{- j 2 π kl}{{N}_{DFT}}} , \qquad ( 1 )$$

where k is an index of the frequency-domain sub-carrier with k∈{−N_{act}/2, . . . N_{act}/2−1}. N_{DFT} represents the size of the DFT, and N_{act} represents the total number of active subcarriers. After the zero padding, if applied, an oversampled signal is converted to time-domain through the inverse DFT as

$$x [ n ] = \frac{1}{\sqrt{N}} {\sum }_{k = 0}^{{N}_{DFT} - 1} X [ k ] {e}^{\frac{j 2 π kl}{N}} , \qquad ( 2 )$$

where n∈{0,1, . . . , N−1} is the index of the corresponding time-domain sample of an OFDM symbol, an N is the total number of time-domain samples for the OFDM symbol. Then, Equation (2) can be written differently by using (1) as

$$x [ n ] = \frac{1}{\sqrt{{N}_{DFT}}} {\sum }_{l = 0}^{{N}_{DFT} - 1} d [ l ] {\sum }_{k = 0}^{{N}_{DFT} - 1} {e}^{\frac{j 2 π kn}{N} \frac{- j 2 π kl}{{N}_{DFT}}} = \frac{1}{\sqrt{{N}_{DFT}}} {\sum }_{l = 0}^{{N}_{DFT} - 1} d [ l ] g [ n - \frac{lN}{{N}_{DFT}} ] , \qquad ( 3 )$$

where the pulse function g(n) is equal to

$$g [ n ] = \frac{1}{\sqrt{N}} {e}^{\frac{j π ( {N}_{DFT} - 1 ) n}{N}} \frac{sin ( {π N}_{DFT} n / N )}{sin ( π n / N )} . \qquad ( 4 )$$

When evaluating a block of modulation symbols subjected to the DFT and subsequent sub-carrier mapping and inverse DFT, it has been discovered that certain combinations of the modulation symbol values result in a higher PAPR than other combinations. Additionally, it has been discovered that the modulation symbols at the center of the block of modulation symbols have the highest contribution to the appearance of the peak(s), if the peak(s) exist(s). Now, the characteristics of such combinations can be exploited to perform early detection of the peaks with low complexity. According to an embodiment, a filter exploiting these characteristics is derived and the block of modulation symbols is filtered with the filter before the peak detection. As described above, the filter approximates the response of at least the DFT and inverse DFT (IDFT) operations with much lower complexity than the DFT and IDFT operations. In an embodiment, the filter is a low-complexity digital filter with a relatively low number of coefficients or taps, e.g. less than 20 taps. The purpose of the filter is to convert a sequence of said modulation symbols into a form that represents the shape of a multi-carrier signal comprising the modulation symbols at an output of the IDFT. Accordingly, the filter enables detection of the peak(s) that would emerge at the output of the IDFT in such manner that the detection can be made from the modulation symbols that are acquired before the DFT operation.

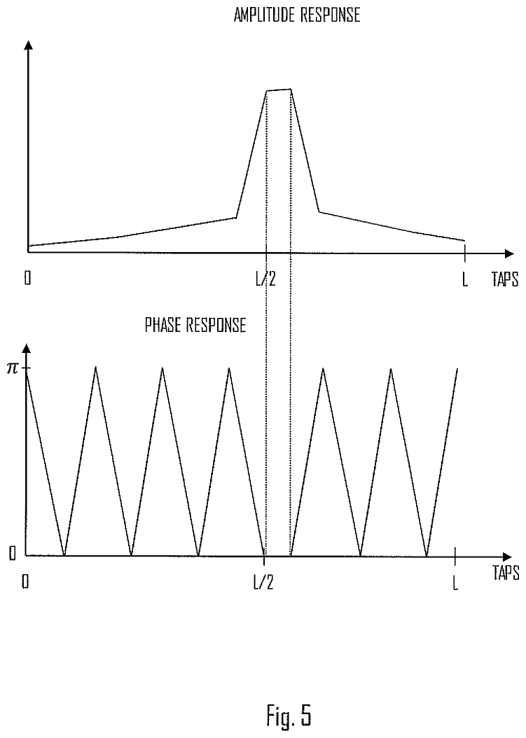

FIG. 5 illustrates a time-domain amplitude response and a phase response of such a filter. As illustrated in FIG. 5, the amplitude response gives high weight to samples at the center of the filter and low weight to samples at the lower and higher end taps of the filter. As mentioned above, it was discovered that the symbols at the center of the block have the highest impact on the PAPR which derives at least partially from a similar amplitude response of the combined DFT and IDFT operations. Also, as illustrated in FIG. 5, the amplitude response is asymmetric with respect to a central tap of the filter such that the taps having high weight are offset from the central tap towards higher taps. For example, if the length of the filter is 15 taps, from 0 to 15, taps 7 to 9 or 7 to 10 or 8 to 10 or 8 and 9 may be assigned with the substantially higher weight than the other taps. For example, the taps having the higher weight may have a coefficient of substantially 1, a value higher than 0.7, or a value higher than 0.5 while the remaining taps may have a value below 0.7 or below 0.5 such that the value reduces from the center taps towards the end taps of the filter at both ends of the filter.

The time-domain phase response of the filter may have a form where at least some of adjacent taps of the filter have an opposite phase value and at least some of the adjacent taps of the filter have an equal phase value. FIG. 5 illustrates a phase response where adjacent taps mainly have the opposite phases. The exception is the central tap and the tap adjacent to the central tap towards the end of the filter, wherein the taps have the same phase value. The correlation between the amplitude response and the phase response is also illustrated in FIG. 5: the taps assigned with the highest weight in the amplitude response are assigned with the same phase in the phase response. Similarly, the taps assigned with the low weight in the amplitude response have the varying phase in the phase response. This characteristic brings out the behavior found to increase the PAPR and sought for in the block of modulation symbols. The response of the filter may be the same or different for different modulation schemes. In some embodiments, the amplitude response may, however, follow the same principle where some of the central taps of the filter are given a higher weight than taps at the ends of the filter. The same central taps may be assigned with the same phase as well.

The filter with the response illustrated in FIG. 5 is an embodiment of a filter capable of distinguishing modulation symbol combinations that result in a peak after the INT. Therefore, filtering the modulation symbols with the corresponding digital filter is capable of bringing out such peaks. Accordingly, subsequent peak detection is capable of detecting the peaks and triggering the peak correction in block 208.

In an embodiment, the filter coefficients have only real values, i.e. no complex values.

After the modulation symbols have been acquired, the filter may be applied to evaluate the summation of these consecutive modulation symbols, and the filtering can be denoted as

$$S ( a ) = {\sum }_{p = {I}_{a} ( 1 )}^{{I}_{a} ( P )} d [ p ] F [ p ] , \qquad ( 5 )$$

where F[l] is the p^{th} value of the filter, and P is the length of the filter. P may equal to the length of the DFT. I_{α} is a function that defines the index value p and can be represented as

$${I}_{a} ( 1 ) = mod ( a - ⌊ \frac{P}{2} ⌋ , {N}_{act} )$$

$$and$$

$${I}_{a} ( P ) = mod ( a + ⌊ \frac{P}{2} ⌋ , {N}_{act} ) ,$$

where N_{act} equals to the total number of sub-carriers carrying either a modulation symbol or a peak correction signal, a is an index of the modulation symbol multiplied by the central tap of the filter, and └.┘ is the floor function. The value S(α) resulting from the filtering may then be compared with a threshold γ in the peak detection. The comparison may be denoted as

$$PS ( a ) = \{ \begin{matrix}central ( a ) , & if S ( a ) \geq γ , \\ null , & otherwise\end{matrix} , \qquad ( 6 )$$

where PS(α) represents a problematic symbol. If no peak is detected, i.e. the value S(α) at the output of the filter is below the threshold, the output of the detection may be ‘null’. Otherwise, the output value of the detection is an index of the central symbol of the filtering that may be computed as

$$central ( a ) = {I}_{a} ( ⌈ \frac{P}{2} ⌉ ) \qquad ( 7 ]$$

where ┌.┐ is the ceiling function.

The filter may be applied to the block of modulation symbols as a sliding window filter and, accordingly, every modulation symbol of the block is considered as the central symbol of the possible problematic symbol group. In this manner, problematic symbols causing the increase in the PAPR can be detected before creating the DFT-s-OFDM waveform. The output of the peak detection may comprise the index of the modulation symbol causing the peak and a phase value of the peak. These values may be used in the computation of the correction signal,

In an embodiment, the threshold is fixed or fixed per modulation scheme. The fixed threshold provides a simplified peak detection where there is no need to adaptively find the appropriate peak. In the embodiment where the threshold is fixed per modulation scheme, the peak detection procedure comprises a step where the appropriate threshold is retrieved from a memory. The step may include determining a modulation scheme applied to the modulation symbols and acquiring a threshold mapped to the modulation scheme in the memory,

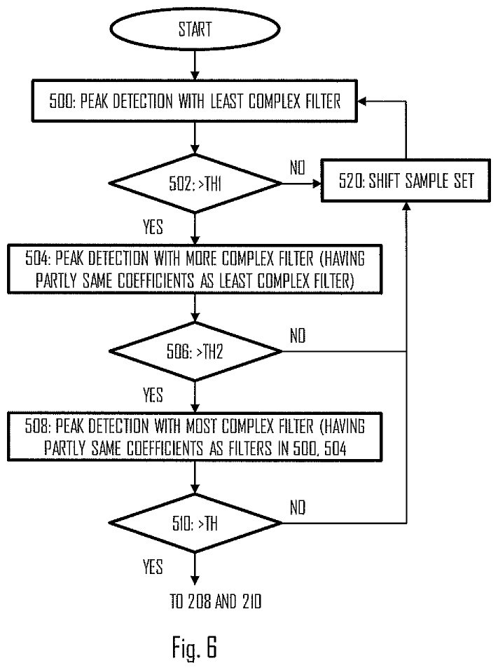

When the filter and the peak detection operate according to the sliding principle, i.e the filtering and peak detection is performed for every modulation symbols at the center of the filter, it would be beneficial to reduce the computational complexity of the filtering and peak detection. When the filter has P taps or coefficients, approximately 2Preal-value multiplications and 2Preal-value additions are performed per modulation symbol. FIG. 6 illustrates an embodiment where the filtering and the peak detection is divided into at least one pre-filtering step where the modulation symbols are first filtered with a simplified filter having similar response as the above-described filter but with less taps/coefficients, i.e. less than P taps. If the peak detection resulting from the pre-filtering results in detection of a peak, the respective filtered sample set is forwarded to the second filtering step having a more complex filter, e.g. the filter with P taps described above. There may be more than one pre-filtering stages, as illustrated in the embodiment of FIG. 6.

Referring to FIG. 6, all the modulation symbols may be run through the first pre-filtering stage and respective peak detection in block 500. The first pre-filtering may be performed with the least complex filter, e.g. on having only the highest coefficients in the amplitude response of FIG. 5, e.g. filter taps indexed from P/2 to P/2+K where K is less than P/2. For example, when the filter has 15 taps, as described above, taps 7, 8, and 9 may be taken into the filter of the first pre-filtering stage. Accordingly, the number of multiplications and additions may be decreased, As illustrated in FIG. 5, the taps at the center have a substantially equal value. The taps may even be arranged to have the equal value which may be scaled to T. Therefore, if the first stage consists of those taps having the equal value scaled to ‘1’, the multiplications may even be avoided and further reduction in complexity may be acquired. Even in a case where there is one tap having a value other than ‘1’, the multiplication may be avoided by scaling the modulation symbols so that the modulation symbol multiplied with the tap other than ‘1’ is scaled to value ‘1’. Accordingly, the value of the ‘non-1’ tap and the values of the other modulation symbols may simply be summed, thus avoiding the multiplications completely. The phase response may naturally be taken into account manipulating the sign of the filter coefficients, e.g. plus sign may be assigned to coefficients having phase value ‘0’ in the phase response, and a minus sign may be assigned to coefficients having a phase value ‘π’ in the phase response. Another alternative would be to change the addition to subtraction for coefficients having an opposite phase value than the other coefficients.

After the first pre-filtering, the output of the first pre-filter is compared with a first threshold in block 502. The threshold may be the same or different for different filtering stages. If the comparison indicates that the threshold is not exceeded and no peak is detected, the process may proceed to block 520 where the next modulation symbol set (sample set) is taken into the first pre-filtering stage. In other words, the sample set is shifted by one modulation symbol. On the other hand, if the threshold is exceeded in the comparison, triggering peak detection, the modulation symbol set may be proceeded to the next filtering stage, e.g. the next pre-filtering stage in block 504.

A filter at the second pre-filtering stage may have a complexity between the filter at the first filtering stage and the full filter having the P taps. The filter at the second pre-filtering stage may have the same taps as the filter at the first pre-filtering stage, thus enabling to use the output of the first pre-filtering as such. One or more additional taps may then be taken from the full filter, e.g. one or more taps adjacent to the taps of the filter at the first pre-filtering stage. Since the filter is different, the threshold in the peak detection in block 506 may also be different. In the same manner as in the first-pre-filtering stage, if the comparison in block 506 indicates that the threshold is not exceeded and no peak is detected, the process may proceed to block 520 where the next modulation symbol set (sample set) is taken into the first pre-filtering stage. On the other hand, if the threshold is exceeded in the comparison, triggering peak detection, the modulation symbol set may be proceeded to the next filtering stage, e.g. the filtering stage with the full filter in block 508.

As described above, the coefficients in both (all) pre-filtering stages may be derived from the coefficients of the full filter having P coefficients. Therefore, some of the computation of the filtering in block 508 that has already been made in the pre-filtering stages may be utilized to reduce the complexity in terms of a number of calculation operations. After the filtering with the filter having P coefficients in block 508, the peak detection with the above-described threshold of the filter may be performed in block 510. If the comparison in block 510 indicates that the threshold is not exceeded and no peak is detected, the process may proceed to block 520 where the next modulation symbol set (sample set) is taken into the first pre-filtering stage. On the other hand, if the threshold is exceeded in the comparison, triggering peak detection, index of the symbol at the center of the filter may be determined and output to the peak correction in blocks 208 and 210.

In the process of FIG. 6, when the whole block of modulation symbols have been processed with the filter, the process may end and a new block of modulation symbols may be acquired.

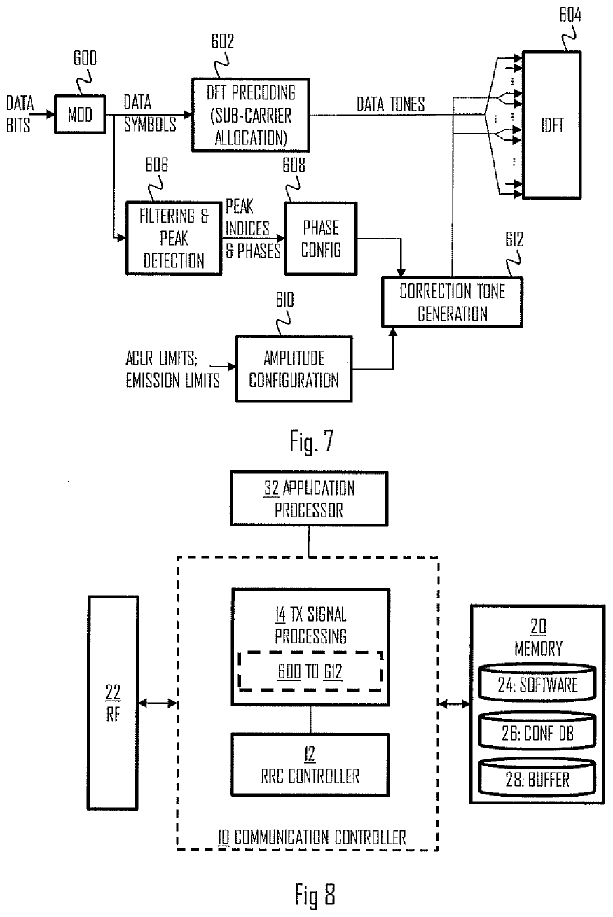

FIG. 7 illustrates an operational block diagram of the procedure for the peak detection and correction in conjunction with the DFT, sub-carrier allocation, and IDFT for the modulation symbols. Referring to FIG. 7, the modulation (data) symbols are acquired as an output of a modulator 600. The modulation symbols may be input to a DFT block 602 and to a filtering and peak detection block 606 that performs blocks 204 and 206 of FIG. 2. The DFT may include precoding functions where the modulation symbols are processed according to DFT precoding principles known in the art. Additionally, the data symbols may be allocated to the sub-carriers in block 602, resulting (data) symbol tones on respective sub-carriers as an output. As an output of block 606, if any peaks are detected, indices of the problematic symbols causing the peaks and respective modulation phase values are applied to a phase configuration block 608. The phase configuration block then computes phase values for the peak correction signal to be allocated to the reserved tones. Phase values of the reserved tones may be computed by subtracting phase values of corresponding IDFT coefficients from a phase value acquired by summing the block of modulation symbols each multiplied by the respective DFT and/or IDFT coefficients. The phase value may be S(α) acquired from Equation (5). Then the computed phase values for the peak correction signal are given as an output. The phase values form phases of the peak correction symbols to be allocated to the reserved tones. As a further input to the phase configuration block, the locations of the reserved tones may be provided.

An amplitude for the peak correction symbols may be computed in an amplitude configuration block 610 receiving, as an input, one or more parameters defining the limitations to the amplitude. Such parameters may include a maximum allowed adjacent channel leakage ratio (ACLR) limit, a maximum permitted emission power limit, etc. Amplitude values of the peak correction symbols are then computed based on the parameter(s). This block needs not to be repeated for all peak correction symbols as the amplitude values are same, if the parameters mentioned above remain the same. Then the computed phase and amplitude values are input to a peak correction tone generation block that generates the peak correction symbols on the respective sub-carriers. Thereafter, the modulation symbols tones and the peak correction tones are combined and input to the IDFT block 604 for the IDFT operation. The peak correction symbols reduce the PAPR at the output of the IDFT, thus improving the efficiency of the following radio frequency operations performed on the signal outputted from the IDFT block 604.

FIG. 8 illustrates an apparatus comprising a processing circuitry, such as at least one processor, and at least one memory 20 including a computer program code (software) 24, wherein the at least one memory and the computer program code (software) are configured, with the at least one processor, to cause the apparatus to carry out the process of FIG. 2 or any one of its embodiments described above. The apparatus may be for the terminal device. The apparatus may be a circuitry or an electronic device realizing some embodiments of the invention in the terminal device. The apparatus carrying out the above-described functionalities may thus be comprised in such a device, e.g. the apparatus may comprise a circuitry such as a chip, a chipset, a processor, a micro controller, or a combination of such circuitries for the terminal device. The at least one processor or a processing circuitry may realize a communication controller 10 controlling communications with the cellular network infrastructure in the above-described manner. The communication controller may be configured to establish and manage radio connections and transfer of data over the radio connections.

The communication controller 10 may comprise an RRC controller 12 configured to establish, manage, and terminate radio connections with the access node(s) of the cellular communication system and the terminal device. The RRC controller 12 may be configured, for example, to establish and reconfigure the RRC connections in the terminal device. The RRC controller may carry out steps 400, 404, and 406 of FIG. 4 performed in the terminal device, for example, to enable the tone reservation in the terminal device.

The communication controller 10 may further comprise a transmission signal processing circuitry 14 configured to carry out the transmission signal processing functions described in any one of the embodiments above. For example, the circuitry 14 may include the modulation, DFT, sub-carrier allocation, IDFT, and peak detection and peak correction functions. With respect to the embodiment of FIG. 7, the circuitry 14 may include the hardware and software for realizing blocks 600 to 612.

The memory 20 may be implemented using any suitable data storage technology, such as semiconductor-based memory devices, flash memory, magnetic memory devices and systems, optical memory devices and systems, fixed memory and removable memory. The memory 20 may comprise a configuration database 26 for storing configuration parameters, e.g. the configurations for the peak detection and correction. The configurations may include the conditions when the peak detection and correction is enabled, threshold(s) for the peak detection, etc. The memory 20 may further store a data buffer 28 for uplink data to be transmitted from the apparatus.

The apparatus may further comprise a communication interface 22 comprising hardware and/or software for providing the apparatus with radio communication capability with one or more access nodes, as described above. The communication interface 42 may include, for example, an antenna, one or more radio frequency filters, a power amplifier, and one or more frequency converters. The communication interface 42 may comprise hardware and software needed for realizing the radio communications over the radio interface, e.g. according to specifications of an LTE or 5G radio interface.

Embodiments related to FIG. 4 involve some functions in the access node. According to an aspect, there is provided an apparatus for the access node, comprising means for performing: receiving, from a terminal device served by the apparatus, a message indicating capability of the terminal device to use sub-carriers reserved for peak correction when transmitting an uplink signal; to determine to enable the sub-carriers reserved for the peak correction; and to transmit, in response to the received message, a configuration of sub-carriers reserved for the peak correction. The configuration may further indicate a position of the sub-carriers reserved for the peak correction and at least condition when the sub-carriers reserved for the peak correction are available to the terminal device.

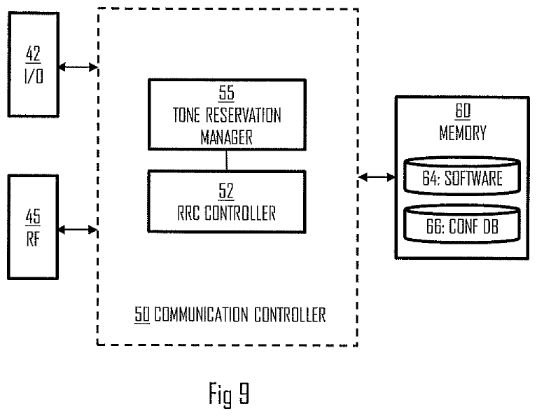

FIG. 9 illustrates such an apparatus comprising a processing circuitry, such as at least one processor, and at least one memory 60 including a computer program code (software) 64, wherein the at least one memory and the computer program code (software) are configured, with the at least one processor, to cause the apparatus to carry out functions of the access node 104 in the process of FIG. 4 or any one of its embodiments described above. The apparatus may be for the access node. The apparatus may be a circuitry or an electronic device realizing some embodiments of the invention in the access node. The apparatus carrying out the above-described functionalities may thus be comprised in such a device, e.g. the apparatus may comprise a circuitry such as a chip, a chipset, a processor, a micro controller, or a combination of such circuitries for the access node. In other embodiments, the apparatus is the access node. The at least one processor or a processing circuitry may realize a communication controller 50 controlling communications with the cellular network infrastructure in the above-described manner. The communication controller may be configured to establish and manage radio connections and transfer of data over the radio connections.

The communication controller 50 may comprise an RRC controller 52 configured to establish, manage, and terminate radio connections with terminal devices served by the access node. The RRC controller 52 may be configured, for example, to establish and reconfigure the RRC connections with the terminal devices. The RRC controller may carry out steps 400 and 404 of FIG. 4, for example, to enable the tone reservation in the terminal device. The communication controller may further comprise a scheduler configured to schedule uplink transmission resources to the terminal devices. In some embodiments, the scheduler may indicate in scheduling grants whether or not the tone reservation is configured for a particular terminal device, as described above.

The communication controller 10 may further comprise a tone reservation manager 55 configured to perform block 402 of FIG. 4. The tone reservation manager may determine whether or not the tone reservation is enabled and configured via the RRC signalling to a particular terminal device.

The memory 60 may be implemented using any suitable data storage technology, such as semiconductor-based memory devices, flash memory, magnetic memory devices and systems, optical memory devices and systems, fixed memory and removable memory. The memory 60 may comprise a configuration database 66 for storing configuration parameters, e.g. the configurations for enabling and disabling the tone reservation for the terminal devices. The configuration database may further store information on the terminal devices for which the tone reservation has been configured, parameters of the respective tone reservation configurations, etc.

The apparatus may further comprise a radio frequency communication interface 45 comprising hardware and/or software for providing the apparatus with radio communication capability with the terminal devices, as described above. The communication interface 45 may include, for example, an antenna array, one or more radio frequency filters, a power amplifier, and one or more frequency converters. The communication interface 42 may comprise hardware and software needed for realizing the radio communications over the radio interface, e.g. according to specifications of an LTE or 5G radio interface.

The apparatus may further comprise another communication interface 42 for communicating towards the core network. The communication interface may support respective communication protocols of the cellular communication system to enable communication with other access nodes, with other nodes of the radio access network, and with nodes in the core network and even beyond the core network. The communication interface 42 may comprise necessary hardware and software for such communications.

As used in this application, the term ‘circuitry’ refers to one or more of the following: (a) hardware-only circuit implementations such as implementations in only analog and/or digital circuitry; (b) combinations of circuits and software and/or firmware, such as (as applicable): (i) a combination of processor(s) or processor cores; or (ii) portions of processor(s)/software including digital signal processor(s), software, and at least one memory that work together to cause an apparatus to perform specific functions; and (c) circuits, such as a microprocessor(s) or a portion of a microprocessor(s), that require software or firmware for operation, even if the software or firmware is not physically present,

This definition of ‘circuitry’ applies to uses of this term in this application. As a further example, as used in this application, the term “circuitry” would also cover an implementation of merely a processor (or multiple processors) or portion of a processor, e.g. one core of a multi-core processor, and its (or their) accompanying software and/or firmware. The term “circuitry” would also cover, for example and if applicable to the particular element, a baseband integrated circuit, an application-specific integrated circuit (ASIC), and/or a field-programmable grid array (FPGA) circuit for the apparatus according to an embodiment of the invention. The processes or methods described in FIG. 2 or any of the embodiments thereof may also be carried out in the form of one or more computer processes defined by one or more computer programs. The computer program(s) may be in source code form, object code form, or in some intermediate form, and it may be stored in some sort of carrier, which may be any entity or device capable of carrying the program. Such carriers include transitory and/or non-transitory computer media, e.g. a record medium, computer memory, read-only memory, electrical carrier signal, telecommunications signal, and software distribution package. Depending on the processing power needed, the computer program may be executed in a single electronic digital processing unit or it may be distributed amongst a number of processing units.

Embodiments described herein are applicable to wireless networks defined above but also to other wireless networks. The protocols used, the specifications of the wireless networks and their network elements develop rapidly. Such development may require extra changes to the described embodiments. Therefore, all words and expressions should be interpreted broadly and they are intended to illustrate, not to restrict, the embodiment. It will be obvious to a person skilled in the art that, as technology advances, the inventive concept can be implemented in various ways. Embodiments are not limited to the examples described above but may vary within the scope of the claims.

1. An apparatus comprising circuitry for performing:
acquiring a block of modulated symbols to be transmitted over a radio interface;
transforming the block of modulated symbols from a time domain into a frequency domain for sub-carrier mapping;
performing a time-domain peak detection procedure on the block of modulated symbols before said transforming;
upon detecting at least one peak in the block of modulated symbols during the time-domain peak detection procedure, computing a peak correction signal for the block of modulated symbols and allocating the peak correction signal to one or more sub-carriers dedicated to the peak correction signal in the sub-carrier mapping; and
upon detecting no peak in the block of modulated symbols during the time-domain peak detection procedure, omitting said computing and said allocating.

2. The apparatus of claim 1, wherein the circuitry are configured, upon detecting no peak in the block of modulated symbols, to leave the sub-carriers dedicated to the peak correction signal empty.

3. The apparatus of claim 1, wherein the circuitry are configured to disable the peak detection procedure when there are available no sub-carriers dedicated to the peak correction signal.

4. The apparatus of claim 3, wherein the circuitry are configured to disable the peak detection procedure in response to detecting no sub-carriers dedicated to the peak correction signal in a scheduling grant message received from a serving access node.

5. The apparatus of claim 1, wherein the circuitry are configured to indicate, to the serving access node, capability for using sub-carriers reserved for peak correction when transmitting an uplink signal.

6. The apparatus of claim 5, wherein the circuitry are configured to receive, in response to indicating the capability to the serving access node, a configuration of sub-carriers reserved for the peak correction, wherein the configuration indicates a position of the sub-carriers reserved for the peak correction and at least condition when the sub-carriers reserved for the peak correction are available to the apparatus.

7. The apparatus of claim 1, wherein circuitry are configured to perform the time-domain peak detection procedure with filtering the block of modulated symbols with a filter having a response approximating a combined response of at least said transforming via a discrete Fourier transform and subsequent inverse discrete Fourier transform operations and with performing peak detection on the filtered block of modulated symbols.

8. The apparatus of claim 7, wherein a time-domain amplitude response of said response has a form where a higher weight is assigned to filter coefficients at a center of the filter than to filter coefficients at an edge of the filter.

9. The apparatus of claim 8, wherein the amplitude response is asymmetric with respect to a central coefficient of the filter such that the amplitude response is offset from the central coefficient towards coefficients at an end of the filter.

10. The apparatus of claim 7 wherein a time-domain phase response of said response has a form where at least some of adjacent coefficients of the filter have an opposite phase value and at least some of the adjacent coefficients of the filter have an equal phase value.

11. The apparatus of claim 1, wherein the circuitry are configured to perform the time-domain peak detection procedure with using a threshold comparison with a threshold and, if the threshold is exceeded in the comparison, detect a peak caused by the modulated symbols, wherein the threshold is fixed per modulation scheme.

12. The apparatus of claim 1, wherein the circuitry comprise at least one processor and at least one non-transitory memory including computer program code, the at least one memory and computer program code configured to, with the at least one processor, cause the performance of the apparatus.

13. A method comprising:
acquiring, with an apparatus, a block of modulated symbols to be transmitted over a radio interface;
transforming, with the apparatus, the block of modulated symbols from a time domain into a frequency domain for sub-carrier mapping;
performing, with the apparatus, a time-domain peak detection procedure on the block of modulated symbols before said transforming;
upon detecting at least one peak in the block of modulated symbols during the time-domain peak detection procedure, computing with the apparatus a peak correction signal for the block of modulated symbols and allocating the peak correction signal to one or more sub-carriers dedicated to the peak correction signal in the sub-carrier mapping; and
upon detecting no peak in the block of modulated symbols during the time-domain peak detection procedure, omitting with the apparatus said computing and said allocating.

14. The method of claim 13, wherein the apparatus is a terminal device of a cellular communication system.

15. A computer program product embodied on a non-transitory computer-readable medium and comprising a computer program code readable by a computer, wherein the computer program code configures the computer to carry out a computer process comprising:
acquiring a block of modulated symbols to be transmitted over a radio interface;
transforming the block of modulated symbols from a time domain into a frequency domain for sub-carrier mapping;
performing a time-domain peak detection procedure on the block of modulated symbols before said transforming;
upon detecting at least one peak in the block of modulated symbols during the time-domain peak detection procedure, computing a peak correction signal for the block of modulated symbols and allocating the peak correction signal to one or more sub-carriers dedicated to the peak correction signal in the sub-carrier mapping; and
upon detecting no peak in the block of modulated symbols during the time-domain peak detection procedure, omitting said computing and said allocating.
